(19) United States
(12) Patent Application Publication
(10) Pub. No.: US 2020/0389051 A1
(43) Pub. Date: Dec. 10, 2020

(54) NON-CONTACT POWER SUPPLY APPARATUS AND NON-CONTACT POWER TRANSMISSION SYSTEM

(71) Applicant: SANKEN ELECTRIC CO., LTD., Niiza-Shi (JP)

(72) Inventors: Takashi MATSUMOTO, Niiza-Shi (JP); Shinji ASO, Niiza-Shi (JP)

(73) Assignee: SANKEN ELECTRIC CO., LTD., Niiza-Shi (JP)

(21) Appl. No.: 16/436,396

(22) Filed: Jun. 10, 2019

(51) Int. Cl. H02J 50/10; H02M 3/158; H02M 7/5387; H02M 1/00; H02J 7/02

(52) U.S. Cl. CPC H02J 50/10; H02M 3/158; H02M 7/5387; H02M 7/04; H02J 7/025; H02M 2001/0009; H02M 1/00

(57) ABSTRACT

A non-contact power supply apparatus is disclosed. A power supply DC converter receives electric power and outputs a direct current. An inverter electrically connected to the power supply DC converter generates an alternating current. A coil electrically connected to the inverter allows the alternating current to flow therethrough. The power supply DC converter autonomously controls output power to decrease an output voltage when the direct current increases.

### BACKGROUND

The disclosure relates to a power supply apparatus and a non-contact power transmission system.

Japanese Patent Application Publication No. 2017-046521 (Patent Literature 1) discloses a non-contact power transmission system capable of stopping non-contact power transmission rapidly when an anomaly due to the power transmission occurs during the non-contact power transmission. The non-contact power transmission system includes a power source ECU which stops power supply by a power supply unit by controlling an inverter when a current generated in the power supply unit exceeds a predetermined threshold due to a short circuit in a power reception coil. The power source ECU estimates the condition of coupling between a power supply coil and the power reception coil, and changes the predetermined threshold depending on the estimated condition of coupling. A communication unit performs wireless communications with a communication unit 370 of a power reception apparatus 20. For example, the communication unit receives, from the communication unit 370, information necessary to estimate the coefficient of coupling between the power supply coil and the power reception coil (such as a received voltage at the power reception apparatus 20).

### SUMMARY

One or more embodiments of non-contact power supply apparatus may include: a power supply DC converter that receives electric power and outputs a direct current; an inverter electrically connected to the power supply DC converter, which generates an alternating current; and a coil electrically connected to the inverter, which allows the alternating current to flow therethrough. In one or more embodiments, the power supply DC converter may autonomously control output power to decrease an output voltage when the direct current increases.

One or more embodiments of non-contact power transmission system may include: a power supply apparatus including: a power supply DC converter that receives electric power and outputs a direct current; an inverter electrically connected to the power supply DC converter, and which generates an alternating current; and a power supply coil electrically connected to the inverter, and which allows the alternating current to flow therethrough; and a power reception apparatus comprising a power reception coil that generates induced power from the alternating current. In one or more embodiments, the power supply DC converter may autonomously control output power to decrease an output voltage when the direct current increases.

### BRIEF DESCRIPTION OF DRAWINGS

FIG. 1 is a block diagram illustrating a non-contact power transmission system according to one or more embodiments;

FIG. 2 is a circuit diagram illustrating a power supply apparatus according to one or more embodiments;

FIG. 3 is a circuit diagram illustrating power supply apparatus according to one or more embodiments;

FIG. 4 is a circuit diagram illustrating a power supply apparatus according to one or more embodiments;

FIG. 5 is a circuit diagram illustrating a power supply apparatus according to one or more embodiments;

FIG. 6 is a chart diagram illustrating output power of a DC converter according to one or more embodiments;

FIG. 7A is a block diagram illustrating a positional relationship between a power supply apparatus and a power reception apparatus, and FIG. 7B is a chart diagram illustrating output power of a DC converter according to one or more embodiments; and

FIG. 8A is a block diagram illustrating a positional relationship between the power supply apparatus and the power reception apparatus, and FIG. 8B is a chart diagram illustrating output power of a DC converter according to one or more embodiments.

### DETAILED DESCRIPTION

Embodiments of the invention are described with referring to drawings. In the respective drawings referenced herein, the same constituents are designated by the same reference numerals and duplicate explanation concerning the same constituents may be omitted. All of the drawings are provided to illustrate the respective examples only. No dimensional proportions in the drawings shall impose a restriction on the embodiments. For this reason, specific dimensions and the like should be interpreted with the following descriptions taken into consideration. In addition, the drawings include parts whose dimensional relationship and ratios are different from one drawing to another.

Prepositions, such as “on”, “over” and “above” may be defined with respect to a surface, for example a layer surface, regardless of that surface's orientation in space. The preposition “above” may be used in the specification and claims even if a layer is in contact with another layer. The preposition “on” may be used in the specification and claims when a layer is not in contact with another layer, for example, when there is an intervening layer between them.

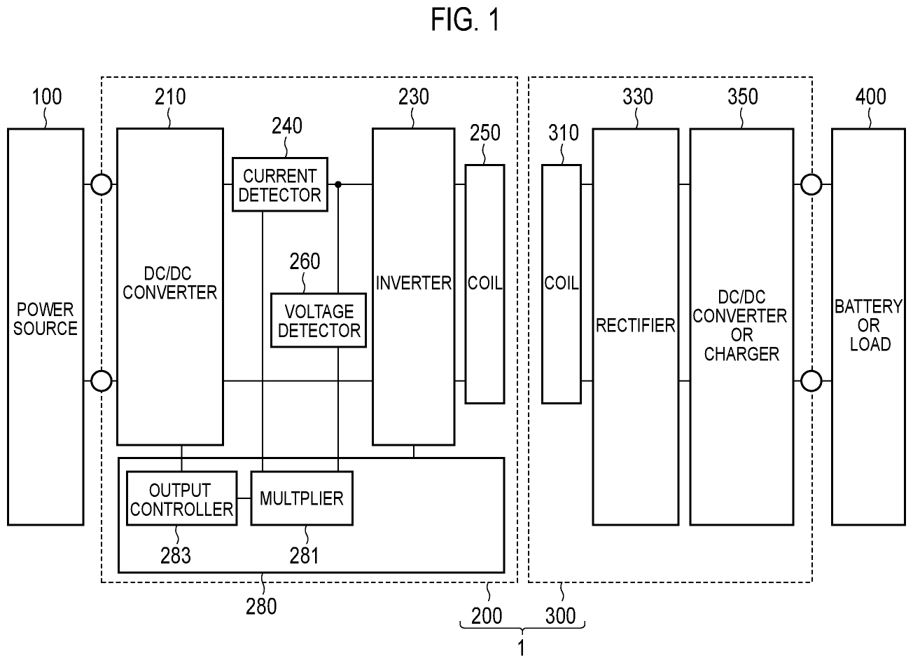

FIG. 1 is a diagram illustrating a non-contact power transmission system 1 according to one or more embodiments. The non-contact power transmission system 1 includes a power supply apparatus 200 and a power reception apparatus 300. The power supply apparatus 200 receives electric power from a power source 100 and preforms non-contact power supply to the power reception apparatus 300. The power reception apparatus 300 receives non-contact power supply from the power supply apparatus 200 and supplies the power to a battery or load 400. The battery or load 400 receives the power from the power reception apparatus 300, and accumulates or consumes the power. The power source 100 and the power supply apparatus 200 may be attachable to and detachable from each other. In other words, the non-contact power transmission system 1 may be attachable to and detachable from the power source 100. The power reception apparatus 300 and the battery or load 400 may be attachable to and detachable from each other. In other words, the non-contact power transmission system 1 may be attachable to and detachable from the battery or load 400.

The power supply apparatus 200 includes a DC converter 210, an inverter 230, and a power supply coil 250. In addition, the power supply apparatus 200 includes a current detector 240, a voltage detector 260, and a controller 280. The power reception apparatus 300 includes a power reception coil 310, a rectifying circuit 330, and a DC converter or charger 350.

The DC converter 210 receives electric power from the power source 100, and outputs direct current. The DC converter 210 may convert a voltage. The conversion of the voltage may be step up or down of the voltage. The current detector 240 detects an output current of the DC converter 210, and transmits the detection result to the controller 280. The voltage detector 260 detects an output voltage of the DC converter 210, and transmits the detection result to the controller 280. The controller 280 receives the detection results from the current detector 240 and the voltage detector 260, and performs output control of either or both of an output voltage and an output current of the DC converter 210 based on these detection results. Specifically, the controller 280 includes a multiplier circuit 281 and an output control circuit 283. The multiplier circuit 281 receives a current signal indicating the detection result from the current detector 240 and receives a voltage signal indicating the detection result from the voltage detector 260. The multiplier circuit 281 multiplies these current signal and voltage signal to generate a power signal. Then, the output control circuit 283 receives the power signal generated by the multiplier circuit 281, and controls an output of the DC converter 210 such that the output will not exceed a reference value.

The inverter 230 receives the direct current from the DC converter 210 and generates an alternating current with a predetermined frequency. The power supply coil 250 receives the alternating current generated by the inverter 230, and allows the current with the predetermined frequency to flow therethrough. The inverter 230 may generate a frequency-modulated alternating current. The frequency-modulated alternating current may be used for controlling output power of the power supply apparatus 200.

The power reception coil 310 generates induced power from the current with the predetermined frequency flowing through the power supply coil 250. The rectifying circuit 330 rectifies the induced power generated. The DC converter or charger 350 receives the direct current from the rectifying circuit 330, converts the direct current into a predetermined-voltage direct current, and outputs the obtained direct current to the battery or load 400. The conversion of the voltage may be step up or down of the voltage. Here, a charging circuit for the battery 400 may be provided in place of the DC converter 350. The battery 400 accumulates electric energy. A load to consume the electric energy supplied may be provided in place of the battery 400.

The non-contact power supply discussed herein includes power supply from the power supply apparatus 200 to the power reception apparatus 300 without connecting them with a wire or the like, in which the power supply apparatus 200 and the power reception apparatus 300 may be in or out of contact with each other.

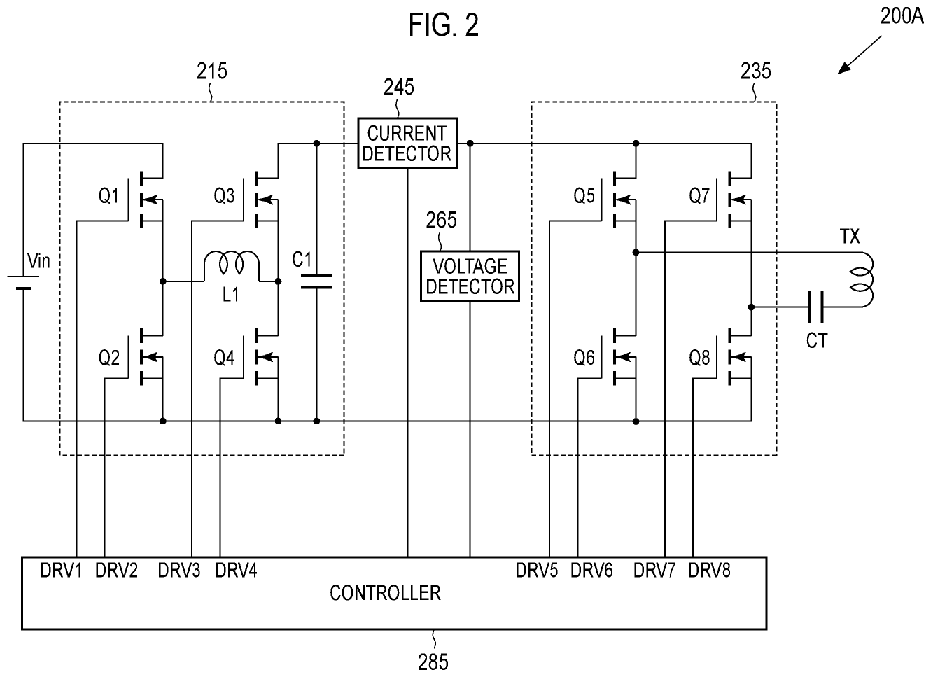

FIG. 2 is a circuit diagram illustrating a power supply apparatus according to one or more embodiments. This power supply apparatus 200A includes an H-bridge converter as a DC converter 215. In addition, the power supply apparatus 200A includes a full-bridge converter configuration as an inverter 235. A current detector 245 detects an output current of the H-bridge converter and a voltage detector 265 detects an output voltage of the H-bridge converter. A controller 285 receives the detection results from the current detector 245 and the voltage detector 265, and performs output control of either or both of an output voltage and an output current of the DC converter 215 based on these detection results.

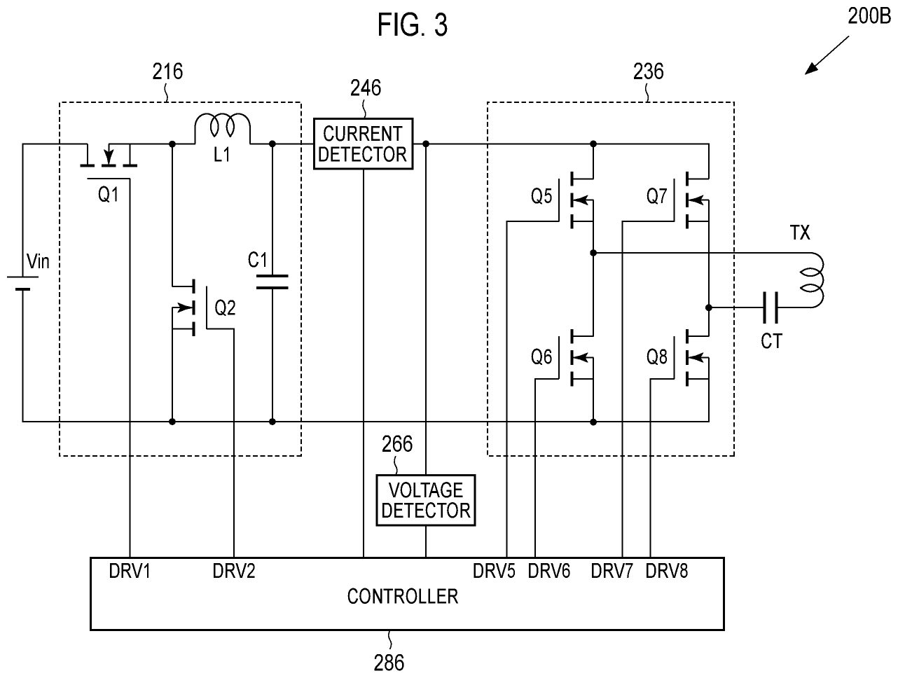

FIG. 3 is a circuit diagram illustrating power supply apparatus according to one or more embodiments. This power supply apparatus 200B includes a voltage step-down converter as a DC converter 216. In addition, the power supply apparatus 200B includes a full-bridge converter configuration as an inverter 236. A current detector 246 detects an output current of the voltage step-down converter and a voltage detector 266 detects an output voltage of the voltage step-down converter. A controller 286 receives the detection results from the current detector 246 and the voltage detector 266, and performs output control of either or both of an output voltage and an output current of the DC converter 216 based on these detection results.

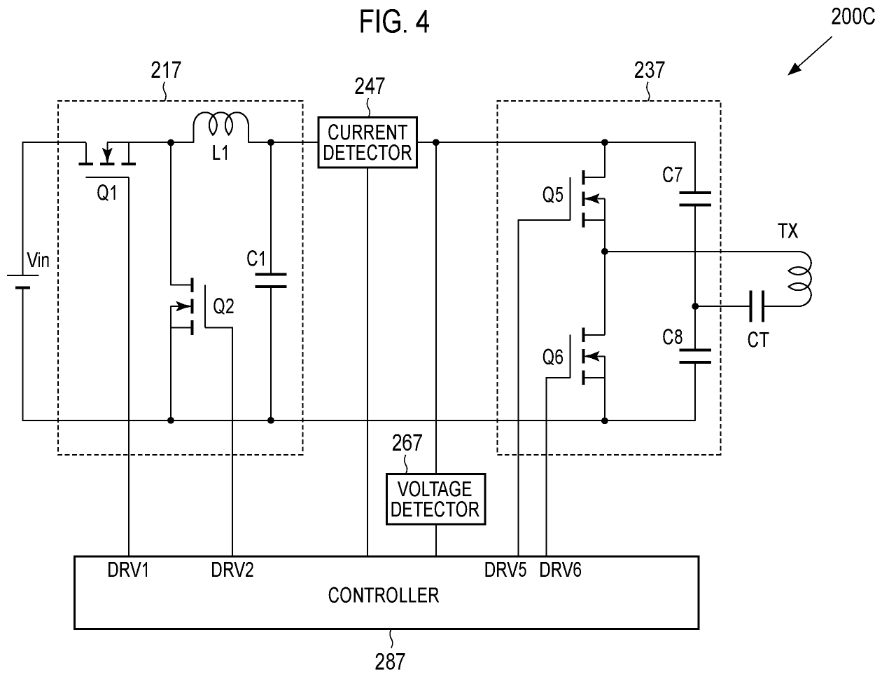

FIG. 4 is a circuit diagram illustrating a power supply apparatus according to one or more embodiments. This power supply apparatus 200C includes a voltage step-down converter as a DC converter 217. In addition, the power supply apparatus 200C includes a half-bridge converter configuration as an inverter 237. A current detector 247 detects an output current of the voltage step-down converter and a voltage detector 267 detects an output voltage of the voltage step-down converter. A controller 287 receives the detection results from the current detector 247 and the voltage detector 267, and performs output control of either or both of an output voltage and an output current of the DC converter 217 based on these detection results.

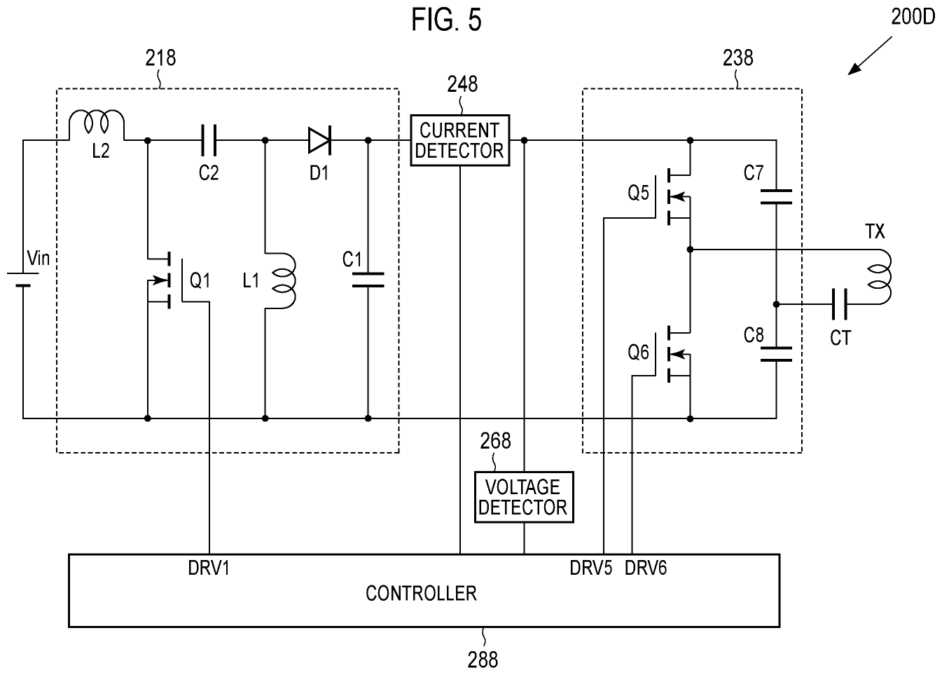

FIG. 5 is a circuit diagram illustrating a power supply apparatus according to one or more embodiments. This power supply apparatus 200D includes a SEPIC converter as a DC converter 218. In addition, the power supply apparatus 200D includes a half-bridge converter configuration as an inverter 238. A current detector 248 detects an output current of the SEPIC converter and a voltage detector 268 detects an output voltage of the SEPIC converter. A controller 288 receives the detection results from the current detector 248 and the voltage detector 268, and performs output control of either or both of an output voltage and an output current of the DC converter 218 based on these detection results.

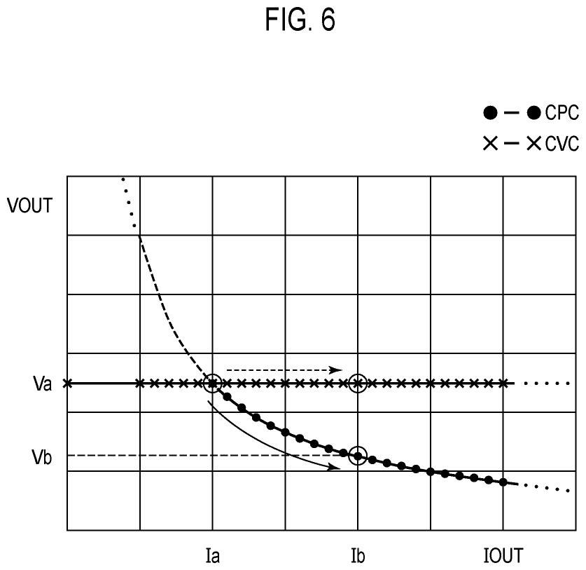

FIG. 6 is a chart diagram illustrating output power of DC converter according to one or more embodiments, in which a vertical axis indicates an output voltage and a horizontal axis indicates an output current. In the chart, black circles present output characteristics of each DC converter 210 according to the embodiment. In the chart, crosses present output characteristics of a comparative example. As shown in FIG. 6, the DC converter 210 controls the output power such that the output voltage decreases as the output current increases. In FIG. 6, assume the following case. Specifically, the DC converter 210 first outputs electric power at an output current Ia and an output voltage Va to the inverter 230. Then, due to a change in any of conditions, the output current changes from Ia to Ib, which is larger than Ia. In this case, the DC converter 210 changes the output voltage from Va to Vb, which is lower than Va (a solid-line arrow in FIG. 6). Even in the case where any of the conditions changes (such as changing positions of power supply apparatus 200 or power reception apparatus 300), such control that the output voltage decreases as the output current increases enables stable power supply, and thereby prevents an over-voltage or over-current from breaking down the apparatus receiving the power, the buttery, or the load. The DC converter 210 may control the current such that the output power, which is defined as the product of the output current lout and the output voltage Vout, may be kept constant. For example, the output current lout and the output voltage Vout may be controlled based on the input voltage or input current of DC converter 210.

In the comparative example, the output control is performed such that the output voltage is kept constant even when the output current increases. In FIG. 6, also assume the following case. Specifically, the converter in the comparative example first outputs output power at an output current Ia and an output voltage Va. Then, due to a change in any of conditions, the output current changes from Ia to Ib, which is larger than Ia. Even in this case, the output voltage Va is kept constant (a broken-line arrow in FIG. 6). In this comparative example, an over-current or an over-voltage may break down the power reception apparatus, the battery or the load for example, when the distance between the power supply coil and the power reception coil changes due to a sharp and sudden change in the conditions.

In the non-contact power transmission system disclosed in Patent Literature 1, both the power supply apparatus and the power reception apparatus include the communication units, and the communication unit in the power supply apparatus performs wireless communications with the communication unit in the power reception apparatus, and receives, from the communication unit 370, information necessary to estimate the coefficient of coupling between the power supply coil and the power reception coil (such as a received voltage at the power reception apparatus 20). Thus, when an over-voltage at the power reception apparatus is detected, the non-contact power transmission system stops the output from the power supply apparatus according to a so-called feedback signal from the power reception apparatus. However, since this feedback signal has to undergo processing such as digital signal conversion, the non-contact power transmission system may fail to cope with a sharp and sudden change in the conditions between the power reception apparatus and the power supply apparatus.

The non-contact power transmission system disclosed in Patent Literature 1 may have a poor ability to follow a change in the conditions between the power reception apparatus and the power supply apparatus as described above. Moreover, since the circuits for communications between the power supply apparatus and the power reception apparatus are required, the circuit scale is disadvantageously large. In addition, since the power supply is stopped when a predetermined condition is met, the system requires a restart or the like, which causes a problem of disabling smooth power supply.

The DC converter 210 having output power characteristics shown in FIG. 6 controls the output power, and thereby is capable of performing autonomous power control without needing any feedback signal from the power reception apparatus. For this reason, even in the case where a sharp and sudden change occurs in the conditions between the power reception apparatus and the power supply apparatus, the DC converter 210 is capable of performing power control by favorably following the change. This enables reduction in a risk of a breakdown of the power reception apparatus due to an over-current, or over-voltage. In addition, the DC converter 210 is configured to stop the output of the power supply apparatus according to a so-called feedback signal from the power reception apparatus when an over-current, or over-voltage at the power reception apparatus is detected. Since the DC converter 210 shown in FIG. 6 controls the output power, the DC converter 210 is capable of performing stable power supply without stopping the output from the power supply apparatus even when a change occurs in the conditions between the power reception apparatus and the power supply apparatus. In one possible configuration, the power reception apparatus is positioned within a predetermined allowable range of positional variation with respect to the power supply apparatus, and receives power supply from the power supply apparatus at any distance within the allowable range of positional variation. In addition, the configuration may be provided with a feedback controller which performs feedback control of the frequency of the inverter in the power supply apparatus such that the output voltage of the rectifying circuit in the power reception apparatus can be kept at a predetermined voltage. Here, the feedback controller may carry out the feedback control of the frequency of the inverter in the power supply apparatus by way of the power reception coil and the power supply coil. For feedback control, the power reception apparatus 300 may communicate with the power supply apparatus 200 via Amplitude shift keying (ASK) back scatter method. The power reception apparatus 300 may modulate the amplitude of the received waveform from power supply apparatus 200. This amplitude variation is reflected back to the power supply apparatus 200, and is demodulated and decoded for controlling output voltage of the power supply apparatus 200. The ASK modulation at power supply apparatus 200 may be done by switching capacitors in parallel with the received AC waveform. This has the effect of extra AC waveform loading, which results in a drop in AC voltage (or an increase in AC current). This change in AC amplitude is reflected back to the power supply apparatus 200. The power supply apparatus 200 then may detect the change in AC waveform, either via voltage or current envelope detection, to demodulate the ASK information as feedback control information. As shown in FIG. 6, the DC converter 210 may output a constant voltage (Va) up to a predetermined output current (Ia.) In the case of the output current larger than a predetermined output current (Ia,) the DC converter 210 may output voltages to output constant power. That is, the DC converter 210 may switch from constant voltage control (CVC) outputting constant voltage until predetermined current to constant power control (CPC) outputting voltages to output constant power when the output current exceeds the predetermined output current.

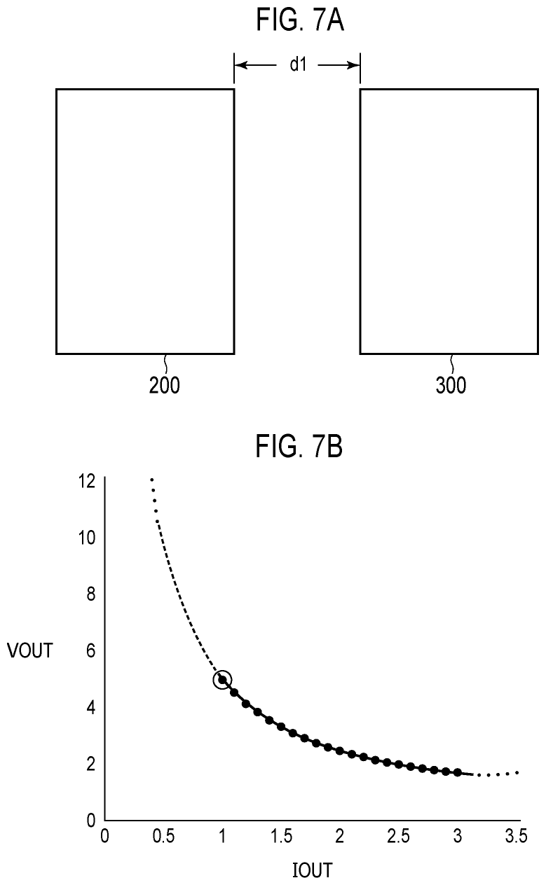

FIGS. 7A and 7B are diagrams illustrating output control of the DC converter 210. In FIG. 7A, assume that the power supply apparatus 200 supplies power to the power reception apparatus 300 while the power supply apparatus 200 and the power reception apparatus 300 are apart at a distance d1. FIG. 7B presents output power according to an embodiment of the DC converter 210, in which a vertical axis indicates an output voltage and a horizontal axis indicates an output current. Here, assume that the power at Iout=1 and Vout=5.0 is outputted under the condition in FIG. 7A.

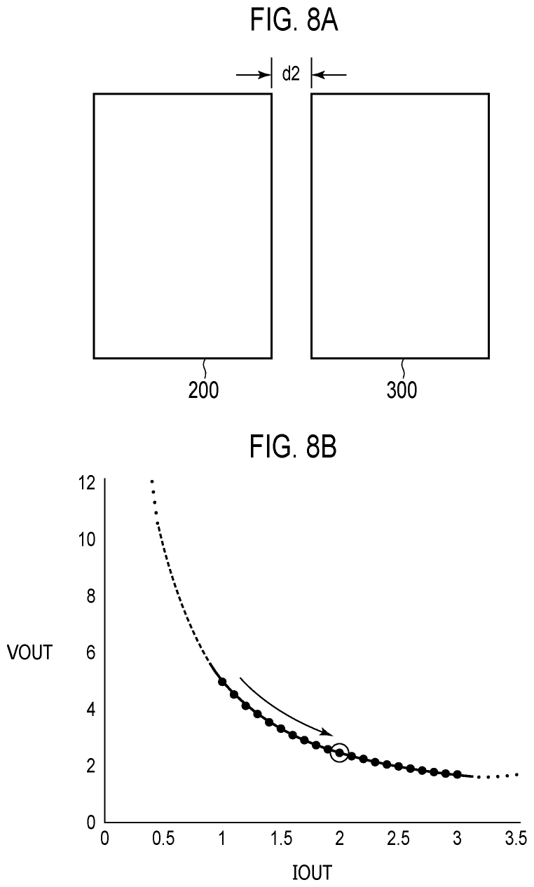

FIGS. 8A and 8B are diagrams illustrating output control of the DC converter 210. In FIG. 8A, assume that the distance d1 between the power supply apparatus 200 and the power reception apparatus 300 is changed to a distance d2, which is shorter than the distance d1. FIG. 8B presents output power according to the embodiment of the DC converter 210, in which a vertical axis indicates an output voltage and a horizontal axis indicates an output current. When the condition in FIG. 7A is changed to the condition in FIG. 8A, there is a possibility that an over-current or an over-voltage at the power reception apparatus 300 due to an increase in the current may cause a breakdown. In this case, the DC converter 210 controls the output. For example, when the output current lout is changed to 2, the DC converter 210 decreases the output voltage Vout to 2.5. This enables reduction in the risk of a breakdown due to an over-current or an over-voltage at the power reception apparatus 300.

In the above embodiments, the change in the conditions occurs due to a change in the distance between the power supply apparatus 200 and the power reception apparatus 300. However, the case where a change in the conditions occurs is not limited to the above one, but also includes, for example, the case where an obstacle exists between the power supply apparatus 200 and the power reception apparatus 300 and the case where the output voltage of the rectifying circuit increases because the power reception apparatus 300 receives a large amount of magnetic flux due to, for example, a change in temperature. The embodiment discussed herein is expected to produce a significant effect in particular, for example, in the case where the positional relationship between the power supply apparatus 200 and the power reception apparatus 300 is not fixed or is varied consistently.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

What is claimed is:

1. A non-contact power supply apparatus comprising:
a power supply DC converter that receives electric power and outputs a direct current;
an inverter electrically connected to the power supply DC converter, which generates an alternating current; and
a coil electrically connected to the inverter that allows the alternating current to flow therethrough, wherein
the power supply DC converter autonomously controls output power to decrease an output voltage when the direct current increases.

2. The non-contact power supply apparatus according to claim 1, further comprising:
a current detector that detects an output current of the power supply DC converter;
a voltage detector that detects an output voltage of the power supply DC converter; and
a controller that controls output of the power supply DC converter based on detection results of the current detector and the voltage detector.

3. The non-contact power supply apparatus according to claim 2, wherein
the controller comprises:
a multiplier that receives a current signal indicating a detection result of the current detector and a voltage signal indicating the detection result of the voltage detector, and calculates a product of the current signal and the voltage signal; and
an output controller that controls output of the power supply DC converter based on the product calculated by the multiplier.

4. The non-contact power supply apparatus according to claim 1, wherein
the power supply DC converter outputs constant power.

5. The non-contact power supply apparatus according to claim 1, wherein
the power supply DC converter switches from constant voltage control outputting constant voltage until predetermined current to constant power control outputting voltages to output constant power when an output current exceeds a predetermined output current.

6. A non-contact power transmission system comprising
a power supply apparatus comprising:
a power supply DC converter that receives electric power and outputs a direct current;
an inverter electrically connected to the power supply DC converter, and which generates an alternating current; and
a power supply coil electrically connected to the inverter that allows the alternating current to flow therethrough, wherein
the power supply DC converter autonomously controls output power to decrease an output voltage when the direct current increases; and
a power reception apparatus comprising a power reception coil that generates induced power from the alternating current.

7. The non-contact power transmission system according to claim 6, wherein
the power reception apparatus is positioned within a predetermined range of positional variation with respect to the power supply apparatus, and receives power supply from the power supply apparatus at a distance within an allowable range of positional variation.

8. The non-contact power transmission system according to claim 6, wherein the power reception apparatus further comprises:
a rectifying and smoothing circuit that rectifies and smooths a received voltage from the power reception coil to convert the received voltage to a direct current voltage; and
a feedback controller that performs feedback control of a frequency of the inverter in the power supply apparatus such that the direct current voltage at the power reception apparatus is kept at a predetermined voltage.

9. The non-contact power transmission system according to claim 8, wherein the feedback controller transmits a feedback signal via the power reception coil and the power supply coil, wherein
the inverter outputs an alternating current with a frequency based on the feedback signal.
